(19) United States
(12) Patent Application Publication
(10) Pub. No.: US 2011/0262873 A1
(43) Pub. Date: Oct. 27, 2011

(54) USE OF COMPOUNDS CONTAINING HALOGEN AND NITROGEN FOR REDUCING MERCURY EMISSIONS DURING COAL COMBUSTION

(76) Inventors: Christopher J. Nalepa, Zachary, LA (US); Robert M. Moore, JR., Baton Rouge, LA (US); Jennifer Moore, Baton Rouge, LA (US)

(21) Appl. No.: 12/667,282

(22) PCT Filed: Jul. 3, 2007
(86) PCT No.: PCT/US2007/072715

§ 371 Date: Dec. 30, 2009

(51) Int. Cl. F23B 90/00; C10L 5/00; B01D 53/64

(52) U.S. Cl. 431/2; 423/210; 44/620; 431/89

(57) ABSTRACT

Processes and systems are provided for using bromine and/or bromide-containing compounds derived from a nitrogen-containing compound, such as ammonia, sulfamic acid, or one or more salts thereof, to reduce mercury emissions during coal combustion.

### BACKGROUND

In 2005, the EPA issued the Clean Air Mercury Rule to cap and reduce mercury emissions from coal-fired power plants. This rule, combined with the EPA's Clean Air interstate Rule (CAR), will require significant reduction in mercury emissions from coal-fired power plants as early as 2010.

Some mercury can be removed from coal-fired power plant flue gas by SO₂ control devices, However, flue gases normally comprise significant quantities of elemental mercury and oxidized mercury; and SO₂ control devices are suitable for removing oxidized mercury, but not elemental mercury. Low levels of bromine, or aqueous solutions of alkali or alkali-earth metal salts of bromine, such as calcium bromide, sodium bromide or potassium bromide, can be used to oxidize mercury in flue gases, However, when the bromide is oxidized, it results in the formation of bromine. At least some of the bromine can interact with elemental mercury to form non-volatile mercury salts, such as HgBr₂. The excess of bromide value relative to the amount of Hg to be removed results in a significant amount of bromine remaining in the flue gas, which is known to be corrosive to scrubber systems and other equipment in the plant.

Given the foregoing, it would be commercially beneficial to have methods for minimizing mercury emissions from coal-fired power plant flue gases that are suitable for removing both oxidized and elemental mercury from the flue gases without causing corrosion in the plant.

### THE INVENTION

This invention meets the above-described needs by providing processes for reducing mercury emissions from coal during combustion, comprising adding composition comprising bromine and/or bromide-containing compound derived from at least one nitrogen-containing compound or one or more salts thereof to the coal either prior to or during combustion. In such processes, the bromine and/or bromide-containing compound can comprise a nitrogen-containing bromide salt, such as ammonium bromide. This invention is beneficial in that the thus-derived bromine and/or bromide-containing compound has a each lower tendency to cause corrosion in plant equipment, as compared to known compounds for oxidizing mercury in flue gases, such as calcium bromide.

Also provided are processes for reducing mercury emissions from flue gas resulting from combustion of coal, comprising adding composition comprising bromine and/or bromide-containing compound derived from at least nitrogen-containing compound or one or more salts thereof to the flue gas.

Also provided are processes for burning coal to reduce the amount of mercury released into the atmosphere comprising: (i) adding composition comprising bromine and/or bromide-containing compound derived from at least nitrogen-containing compound or one or more salts thereof to the coal; (ii) delivering the coal into a coal burning furnace; (iii) combusting the coal containing the composition in the coal burning furnace to produce ash and combustion gases; (iv) measuring a mercury level in the combustion gases; and (v) adjusting the amount of the composition applied to the coal based on the value of the mercury level.

Also provided are systems for burning coal with reduced levels of mercury released outside the system, comprising: (a) composition comprising bromine and/or bromide-containing compound derived from at least nitrogen-containing compound or one or more salts thereof; (b) a coal burning furnace comprising a burning chamber, a convection path for combustion gases leading from the burning chamber to an exit outside the convection path, and a particle collection device disposed in the convection path; (c) an apparatus for delivering coal to the furnace for combustion; (d) an apparatus disposed in the convection path for measuring the level of mercury in the convection path; (e) a composition delivery apparatus disposed to deliver the composition into the coal before delivery of the coal into the furnace; and (f) a controller disposed to receive an output signal from the mercury measuring apparatus, and operationally connected to the composition delivery apparatus to adjust the delivery of the composition based upon the value of the output signal.

Bromine and/or Bromide-Containing Compounds

Bromine and/or bromide-containing compounds derived from at least nitrogen-containing compound or one or more salts thereof useful in this invention include the following, without hereby limiting this invention; compounds derived from at least ammonia, sulfamic add, urea, one or more hydantoin, biuret, succinimide, a lower aliphatic mono- or disubstituted urea containing from about 2 to about 4 carbon atoms in each substituent group, an alkyl sulfamide, and the like; nitrogen-containing bromide salts and other compounds, such as ammonium bromide; composition derived from BrCl and sodium sulfamate (NaSO₃NH₂) sold under the tradename STABROM 909 by Albemarle Corporation (as described, e.g., in U.S. Pat. No. 6,088,661); and stabilized aqueous alkali or alkaline earth metal hyprobromite solution sold under the tradename STABREX by Nalco (as described, e.g., in U.S. Pat. No. 5,683,654)

### Treatment of Coal to Reduce Mercury Emissions During Combustion

In methods and systems of this invention, composition comprising bromine and/or bromide-containing compound derived from at least nitrogen-containing compound or one or more salts thereof, or at least a portion of the composition, can added to coal either before or during coal combustion to reduce mercury emissions during combustion.

Composition comprising bromine and/or bromide-containing compound as described herein can be added to/onto coal prior to its combustion. For example, the coal can be particulate coal, and can optionally be pulverized or powdered according to conventional procedures. The composition can be added onto the coal as a liquid or as a solid. Generally, solid compositions are in the form of a powder. If the composition is added as a liquid, the coal can remain wet when fed into the burner. The composition can be added onto the coal continuously at the coal burning facility by spraying or mixing onto the coal while it is on a conveyor, screw extruder, or other feeding apparatus. In addition or alternatively, the composition may be separately mixed with the coal at the coal burning facility or at the coal producer. The composition can be added as a liquid or a powder to the coal as it is being fed into the burner. For example, the composition can be applied into the pulverizers that pulverize the coal prior to injection. If desired, the rate of addition of the composition can be varied to achieve a desired level of mercury emissions. The level of mercury in the flue gases can be monitored and the level of composition addition adjusted up or down as required to maintain the desired mercury level.

The composition comprising bromine and/or bromide-containing compound as described herein can be added to coal in batch or continuously. With continuous addition, the treat levels can be based on the feed rate of the coal being burned. Where the composition is added in batch, such as at the coal, producer or at a separate mixing facility, the treat level can be based on the weight of the coal being treated. Additionally, the rate of addition or the treat level can be adjusted based on a determination of emitted levels of mercury.

Treatment of Flue Gas from Coal-Fired Power Plant to Reduce Mercury Emissions

Also in methods and systems of this invention, composition comprising bromine and/or bromide-containing compound derived from at least nitrogen-containing compound or one or more salts thereof, or at least a portion of, the composition, can be added to mercury-containing exhaust as to reduce emission of mercury with the gas. For example, the composition can be added to flue gas in coal-fired power plants to reduce mercury emissions.

The composition can be inserted or injected into the convective pathway of the coal burning facility to reduce the mercury levels. The composition can be added into a zone of the convective pathway downstream of the fireball (caused by combustion of the coal), which zone has a temperature above about 1500° F. (816° C.) and less than the fireball temperature of about 2200° F. (1204° C.). As with pre-combustion addition, the composition can be in the form of a liquid or a solid (powder). The rate of addition of composition into the convective pathway be varied depending on the results of mercury monitoring as described herein.

For either treatment of the coal or the flue gas, the composition can be added in an amount such that there is at least about 2000 ppm bromine or bromide value based on the coal to be/being burned to effect at least about 90% reduction in mercury emissions in the flue gas. Given the teachings of this specification, one skilled in the art can determine the amount of composition needed to provide at least about 2000 ppm bromine or bromide value, and can determine ppm of bromine/bromide value desired to obtain, e.g., 70% reduction, 80% reduction, etc. Typically for a liquid solution, more can be used, as compared to solid of the same composition. For example when the composition comprises NH₄Br, at least about 7500 ppm on a weight basis of 35 wt % NH₄Br solution, or at least about 2500 ppm on a weight basis of solid NH₄Br (100% active), can be added, based on the coal to be/being burned. Also, given the teachings of this specification, one skilled in the art can determine the appropriate amounts of composition to effect, e.g., at least about 70% reduction in mercury emissions in the flue gas, at least about 80% reduction, etc.

When methods and systems of this invention are utilized, mercury emissions into the environment from the coal burning facility are reduced by at least about 70%, at least about 80%, or even at least about 90%, based on the total mercury in the coal being burned. As used in this application, a mercury reduction of at least about 70% means at least about 70% of the mercury in the coal being burned is captured to prevent its release into the atmosphere. A sufficient amount of composition comprising bromine and/or bromide-containing compound as described herein can be added to the coal prior to or during combustion to reduce the mercury emissions into the environment by at least about 70% or more, or can be used to treat the flue gas to obtain the same result, or a portion of the composition can be added to the coal prior to or during combustion and a portion of the composition can be used to treat the flue gas.

Mercury levels can be monitored with conventional analytical equipment using industry standard detection and determination methods. Monitoring can be conducted periodically, either manually or automatically. For example, mercury emissions can be monitored once an hour to ensure compliance with government regulations. To illustrate, the Ontario Hydro method can be used. In this known method, gases are collected for a pre-determined time, for example one hour. Mercury is precipitated from the collected gases, and the level is quantitated using a suitable method such as atomic absorption. Monitoring can also be done more or less frequently than once an hour, depending on technical and commercial feasibility. Commercial continuous mercury monitors can be set to measure mercury and produce a number at a suitable frequency, for example once every 3-7 minutes. The output of the mercury monitors can be used to control the rate of addition of compositions comprising bromine and/or bromide-containing compound as described herein. Depending on the results of monitoring, the rate of addition of the composition can be adjusted by either increasing the level of addition, decreasing it, or leaving it unchanged. To illustrate, if monitoring indicates mercury levels are higher than desired, the rate of addition of composition can be increased until mercury levels return to a desired level. If mercury levels are at desired levels, the rate of composition addition can remain unchanged. Alternatively, the rate of composition addition can be lowered until monitoring indicates it should be increased to avoid high mercury levels.

Mercury can be monitored in the convective pathway at suitable locations. For example, mercury released into the atmosphere can be monitored and measured on the clean side of the particulate control system. Mercury can also be monitored at a point in the convective pathway upstream of the particulate control system. Experiments show that as much, as 20 to 30% of the mercury in coal is captured in the ash and not released into the atmosphere when no mercury emission reduction agent is added. Addition of compositions according to this invention raises the amount of mercury capture (and thus reduces the amount of mercury emissions) to at least about 70%.

Mercury emissions can be monitored using industry standard methods such as those published by the American Society for Testing and Materials (ASTM) or international standards published by the International Standards Organization (ISO). An apparatus comprising an analytical instrument can, be disposed in the convective path ay downstream of the addition points of compositions comprising bromine and/or bromide-containing compound according to this invention. For example, a mercury monitor can be disposed on the clean side of the particulate control system. The measured level of mercury can be used to provide feedback signals to pumps, solenoids, sprayers, and other devices that are actuated or controlled to adjust the rate of addition of composition into the coal burning system. Alternatively or in addition, the rate of composition addition can be adjusted by a an operator based on the observed levels of mercury emissions.

### EXAMPLES

The following examples are illustrative of the principles of this invention. It is understood that this invention is not limited to any one specific embodiment exemplified herein. whether in the examples or in the remainder of this patent application.

### Example 1

NH₄Br solid is added to a Powder River Basin sub-bituminous coal. The coal has the following average properties: moisture content 2.8%; ash content 4.2%; and heat value 10,500 BTU/lb. The solid NH₄Br is added to the ground coal to afford a bromine value in the resultant blend of 0.2 wt %. The blended coal is fed into a coal combustion furnace and heated to between 1500° F. (816° C.) and 2200° F. (1204° C.). A 90% reduction of mercury results in the resultant flue gas as determined by measurements at the bag house outlet based on comparison to control (no added NH₄Br).

### Example 2

STABROM 909 is added to the same Powder River Basin sub-bituminous coal as in Example 1. The bromine value in the resultant blend is 0.18 wt %. The blended coal is fed into a coal combustion furnace as in Example 1, resulting in a 93% reduction of mercury in the flue gas, as determined in Example 1.

Processes of this invention are particularly advantageous in that the presence of nitrogen reduces the amount of bromine that leaches out of the system from ash and forms organic bromides. Instead, the primary source of bromine leaching out of the system is inert bromide salts, which are considered more environmentally acceptable.

While the present invention has been described in terms of one or more preferred embodiments, it is to be understood that other modifications may be made without departing from the scope of the invention, which is set forth in the claims below.

What is claimed is:

1. A process for reducing mercury emissions from coal during combustion, the process comprising adding composition comprising bromine and/or bromide-containing compound derived from at least one nitrogen-containing compound or one or more salts thereof to the coal either prior to or during combustion.

2. The process of claim 1 wherein the bromine and/or bromide-containing compound comprises a nitrogen-containing bromide salt.

3. The process of claim 2 wherein the nitrogen-containing bromide salt comprises ammonium bromide.

4. The process of claim 2 wherein the nitrogen-containing bromide salt comprises a 35 wt % ammonium bromide solution in an amount of at least about 7500 ppm on a weight basis, based on the weight of the coal.

5. The process of claim 2 wherein the nitrogen-containing bromide salt consists essentially of solid ammonium bromide in an amount of at least about 2500 ppm on a weight basis, based on the weight of the coal.

6. A process for reducing mercury emissions from flue gas resulting from combustion of coal, the process comprising adding composition comprising bromine and/or bromide-containing compound derived from at least nitrogen-containing compound or one or more salts thereof to the flue gas.

7. The process of claim 6 wherein the bromine and/or bromide-containing compound comprises a nitrogen-containing bromide salt.

8. The process of claim 7 wherein the nitrogen-containing bromide salt comprises ammonium bromide.

9. A process for burning coal to reduce the amount of mercury released into the atmosphere comprising:
(i) adding composition comprising bromine and/or bromide-containing compound derived from at least nitrogen-containing compound or one or more salts thereof to the coal;
(ii) delivering the coal into coal burning furnace;
(iii) combusting the coal containing the composition in the coal burning furnace to produce ash and combustion gases;
(iv) measuring a mercury level in the combustion gases; and
(v) adjusting the amount of the composition applied to the coal based on the value of the mercury level.

10. A system for burning coal with reduced levels of mercury released outside the system, comprising:
(a) composition comprising bromine and/or bromide-containing compound derived from at least nitrogen-containing compound or one or more salts thereof;
(b) a coal burning furnace comprising a burning chamber, a convection path for combustion gases leading from the burning chamber to an exit outside the convection path, and a particle collection device disposed in the convection path;
(c) an apparatus for delivering coal to the furnace for combustion;
(d) an apparatus disposed in the convection path for measuring the level of mercury in the convection path;
(e) a composition delivery apparatus disposed to deliver the composition into the coal before delivery of the coal into the furnace; and
(f) a controller disposed to receive an output signal from the mercury measuring apparatus, and operationally connected to the composition delivery apparatus to adjust the delivery of the composition based upon the value of the output signal.
